(19) United States
(12) Patent Application Publication
(10) Pub. No.: US 2005/0108755 A1
(43) Pub. Date: May 19, 2005

(54) Multi-source programming guide apparatus and method

(75) Inventors: Yuko Nishikawa, La Jolla, CA (US); Dayan Golden, San Diego, CA (US); Michael A. Bergeron, Poway, CA (US); Himgan Wibisono, San Francisco, CA (US); Philip McKay, San Francisco, CA (US)

Correspondence Address: FITCH EVEN TABIN & FLANNERY, 120 SOUTH LASALLE SUITE 1600, CHICAGO, IL, 60603, US

(73) Assignees: Sony Corporation, a Japanese corporation, Tokyo (JP); Sony Electronics Inc., a Delaware corporation, Park Ridge, NJ (US)

(21) Appl. No.: 10/806,767

(22) Filed: Mar. 23, 2004

Related U.S. Application Data
(60) Provisional application No. 60/520,752, filed on Nov. 17, 2003.

(51) Int. Cl. H04N 5/445; G06F 13/00; G06F 3/00; H04H 9/00

(52) U.S. Cl. 725/47; 725/38; 725/39; 725/13

(57) ABSTRACT

Programming material from various sources and/or of various types are aggregated and filtered with respect to common selection criteria. In one embodiment the selection criteria corresponds to a present viewer.

### PROVISIONAL APPLICATIONS

We claim the benefit of Provisional Patent Application No. 60/520,752, entitled “Ring Interface for TV Programming Guide” and as filed on Nov. 17, 2003.

### RELATED APPLICATIONS

This application relates to each of the following applications, each of which is commonly owned and was filed on an even date herewith and each of which is hereby incorporated by this reference:
3 DIMENSIONAL BROWSING AND SELECTION APPARATUS AND METHOD (attorney's docket number 81231);
INTERACTIVE PROGRAM GUIDE WITH PREFERRED ITEMS LIST APPARATUS AND METHOD (attorney's docket number 81233);
DISPLAY FILTER CRITERIA AND RESULTS DISPLAY APPARATUS AND METHOD (attorney's docket number 81234);
FILTER CRITERIA AND RESULTS DISPLAY APPARATUS AND METHOD (attorney's docket number 81205);
AUTOMATIC CONTENT DISPLAY APPARATUS AND METHOD (attorney's docket number 81232);
CANDIDATE DATA SELECTION AND DISPLAY APPARATUS AND METHOD (attorney's docket number 81229);

### TECHNICAL FIELD

This invention relates generally to interactive programming guides.

### BACKGROUND

Information displays of various kinds are essentially ubiquitous in modern society. Many such displays serve, at least in part, to present content options to a viewer. As the number, kind, and constitution of such content options expand, a concurrent challenge arises to facilitate a way to navigate such options in a manner that is helpful and meaningful to the viewer.

Interactive programming guides are an example of such challenges. With cable, fiber, and/or satellite broadband services facilitating the delivery of an increasing number of varied programming options at any given time, it becomes more important to present a viewer with useful and helpful interface mechanisms to permit the viewer to be informed regarding available content options as the sheer magnitude of programming options renders unlikely the possibility that the viewer will be otherwise sufficiently knowledgeable in this regard.

Present suggestions regarding interactive programming guides as used with various audio/visual content services often present a number of candidate programming options on a display. In some cases this display will include a short textual description of the content of one or more of the candidate programming options or other static information (such as a rating, a brief listing of key actors, a year of publication, and the like).

Display criteria filters are sometimes used to limit in some predetermined or selectable fashion the particular candidate programming options that are available for display. For example, a viewer may be offered the option to limit the displayable pool of programming options to only those options that are presently available for viewing. While helpful in some instances to facilitate the content selection process, such an approach does not meet the needs of all viewers under all viewing circumstances.

For example, in general, each content service or platform tends to foster its own unique and isolated programming guide paradigm. Some viewers, however, have access to more than one programming source. For example, a given viewer may have access to broadcast television reception, cable television, satellite television, and Internet-based streaming delivery services, to name a few. To assess all of their potential viewing options at any given time, such a viewer will typically be forced to review multiple programming guides using different interfacing techniques and actions to successfully filter, navigate, and review such options. This can present a considerable learning curve and also require significant time in practice.

### BRIEF DESCRIPTION OF THE DRAWINGS

The above needs are at least partially met through provision of the multi-source programming guide apparatus and method described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention;

FIG. 3 comprises a flow diagram as configured in accordance with various embodiments of the invention;

FIG. 4 comprises a flow diagram as configured in accordance with various embodiments of the invention; and

FIG. 5 comprises a display as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

Generally speaking, pursuant to these various embodiments, access to a plurality of differing discrete selectable items of audio/video content is provided. At least some of these items differ from one another with respect to at least one of:
the bearer media used to convey the programming to the viewer (for example, some content may be provided by a cable service provider via coaxial cable while other content is provided by a satellite service provider via wireless satellite-based transmissions);
the primary transmission service provider (for example, some content may be provided by a first satellite service provider while other content is provided by a second, different satellite service provider); and/or
data format (for example, some content may be digitized pursuant to one standard of processing while other content may be in analog form or digitized pursuant to another standard of processing).

Pursuant to these various embodiments, characterizing descriptors as individually correspond to these various discrete selectable items of data are provided. In a preferred embodiment the characterizing descriptors comprise any of a variety of descriptors as may be relevant to a variety of audio/visual programs. At least one selection criterion is then provided and applied with respect to the characterizing descriptors of these differing items of audio/video content to effect the identification and ultimate display of programming guide information regarding programs that are selected as a result of application of the selection criterion. In a preferred embodiment the candidate programs are processed as an aggregate and the resultant programming guide information displays the resultant selection as a whole as well.

So configured, the fact that the viewing material available to the viewer stems from differing sources becomes essentially transparent. Instead, the viewer can interact with a large quantity of differently-sourced material in a common fashion to identify their preferred viewing choices.

The selection criterion or criteria can be attained in a variety of ways. In one embodiment a generic or standard filter set can be employed. In a more preferred embodiment criteria of particular import to a given viewer are used. The latter can be obtained, for example, by accessing previously stored information to this effect and/or by requesting a current expression of viewer preferences, depending upon the embodiment employed.

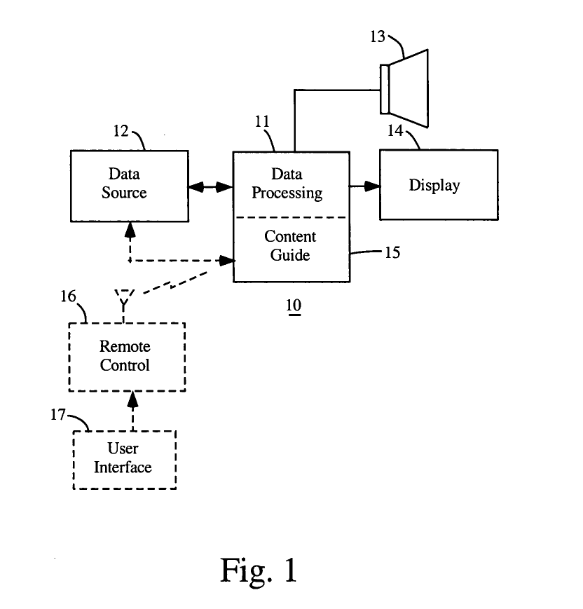

Referring now to the drawings, and in particular to FIG. 1, an apparatus 10 suitable to support and facilitate these teachings can comprise a data processing unit 11 that processes information from a data source 12 (or, more preferably, multiple sources) and provides corresponding audio information to an audio processing path 13 and video information to a display 14.

The control circuitry of the data processing unit 11 can be embodied in a variety of ways. For example, the data processing unit 11 can comprise a fixed-purpose dedicated platform or can comprise a partially or fully programmable platform. Such options and architectural alternatives are well understood in the art and need no further elaboration here. In some embodiments, as with a so-called cable or satellite set-top box, the data processing unit 11 can be readily realized through appropriate programming of the processor as typically accompanies such an apparatus.

The data source 12 can comprise any presently known or hereafter developed data source. In a preferred embodiment there are multiple such data sources that provide to audio/visual content such as television programs and movies. These multiple data sources can provide access to wireless broadcast reception services, cable or optical fiber services, and/or satellite services, to name a few (either alone or in conjunction with one another). Depending upon the needs of the application, it is also possible that the data source 12 provides access to discrete selectable items of audio/visual content as are embodied in a plurality of media. For example, the data source 12 may provide access to cable programming options, satellite programming options, and local programming options as may be available via one or more local or otherwise available media drives (such as but not limited to video tape drives or digital video disk (DVD) drives). It is also possible that the data processing unit 11 operably couple to a plurality of such data sources to permit access to corresponding programming services and viewing options. As will be well understood by those skilled in the art, such a data source (or sources) may interact with a plurality of different bearer media, primary transmission service providers, and/or data formats to ensure available and compatible provision of desired content.

In a preferred embodiment this apparatus 10 further comprises a content guide 15 such as an interactive programming guide. This content guide 15 can comprise an integral part of the data processing unit 11 (as suggested by the illustration in FIG. 1) or can comprise a physically separate platform that operably couples to the data processing unit 11. The content guide 15 can receive information regarding programming options in any of a variety of ways. For example, the data source 12 itself can source such information (either via the data processing unit 11 or directly via a dedicated coupling between itself and the content guide 15 engine). As another example, the content guide 15 can obtain such programming information in other ways such as via a dial-up link (not shown) that facilitates access to a server that provides such information.

In a preferred embodiment the content guide 15 further comprises at least one characterizing descriptor filter. The particular filter(s) used can be selected as appropriate to the given needs and specific requirements of a given application. Some filter examples include, but are not limited to, a genre filter (with filter criteria such as “all,” “children's programming,” “comedy,” “drama,” “documentary,” “favorites list,” “service provider's recommendations,” “audio only,” and the like), a temporal filter (with filter criteria such as “now,” “upcoming within the next hour,” “tomorrow,” “previously recorded,” and the like), or a media/source filter (with filter criteria such as “broadcast television,” “satellite service 2,” “cable service 1,” “Internet content,” “DVD bank 1,” “digital video recorder 3,” and the like).

Through use of such a filter, an initial aggregate pool of candidate viewing choices from a plurality of different sources and/or of different format can be reduced on the basis of the filter selection criteria. For example, by selecting a filter criterion of “children” for such a filter, only children's programming would be made available for selection browsing and navigation.

Content guides are generally well understood in the art. The particular configuration and/or general operation of such engines is not especially important to these embodiments and any suitable content guide engine can be utilized provided one imbues that engine with the ability to hold and deal in the aggregate with programming options from differing sources and/or of differing types. Therefore additional detailed description will not be provided here regarding content guides except where appropriate below with respect to the description of these embodiments.

It will be understood that such apparatus 10 are often at least partially responsive to an optional wireless remote control 16. The latter often use infrared technology to facilitate communications but any wireless technology as may be appropriate to the needs of a given application can be utilized. In many instances such a remote control 16 will include a user interface 17 such as, for example, a keypad. Such a keypad will provide one or more keys that, when asserted by a user, will cause transmission of a particular corresponding wireless instruction by the remote control 16. Pursuant to a preferred embodiment, the operations of the content guide 15 will be at least partially configurable and/or otherwise controllable by appropriate remote control signals. Again, such remote controls are well understood in the art and require no further elaboration here.

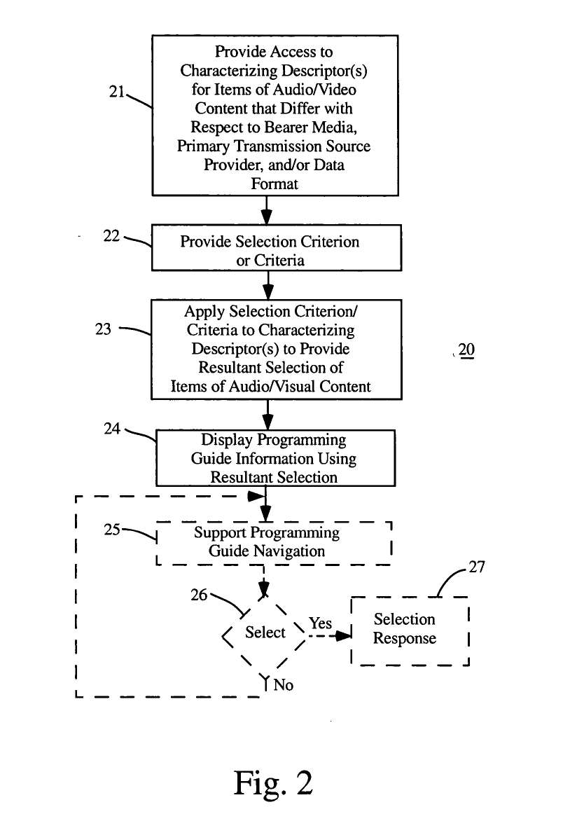

Referring now to FIG. 2, a process 20 that is readily supported by such an apparatus 10 (or that can be alternatively effected through any other suitable architectural configuration of choice) will be described. This process 20 provides for access 21 to characterizing descriptors as individually correspond to a plurality of discrete selectable items of audio/visual content (such as individual movies or television programs). These selectable items of audio/visual content differ from one another with respect to at least one of their respective bearer media, their primary transmission service provider, and/or their data format.

The characterizing descriptors for such items of audio/visual content can be many and varied and can include, for example, a programming network identifier (such as the network call sign for a station that will broadcast or otherwise source the particular program), a broadcast starting time (or stopping time) for the program, a description (such as a textual description) of (or that otherwise pertains to) the audio/visual work, and an indication of the content media source itself (such as whether the program is available by cable, satellite, local media, or the like). The characterizing descriptors can also include samples of the video (and/or audio content) of the item itself and/or a previously prepared trailer or other preview or promotional sample for the item.

This process 20 then provides 22 at least one selection criterion to be applied with respect to this body of data. Such a selection criterion can comprise a default or otherwise predefined generic criterion as may be provided, automatically or otherwise, for use by the programming guide. In a more preferred approach, however, the selection criterion relates more uniquely to the present or general interests of the viewer.

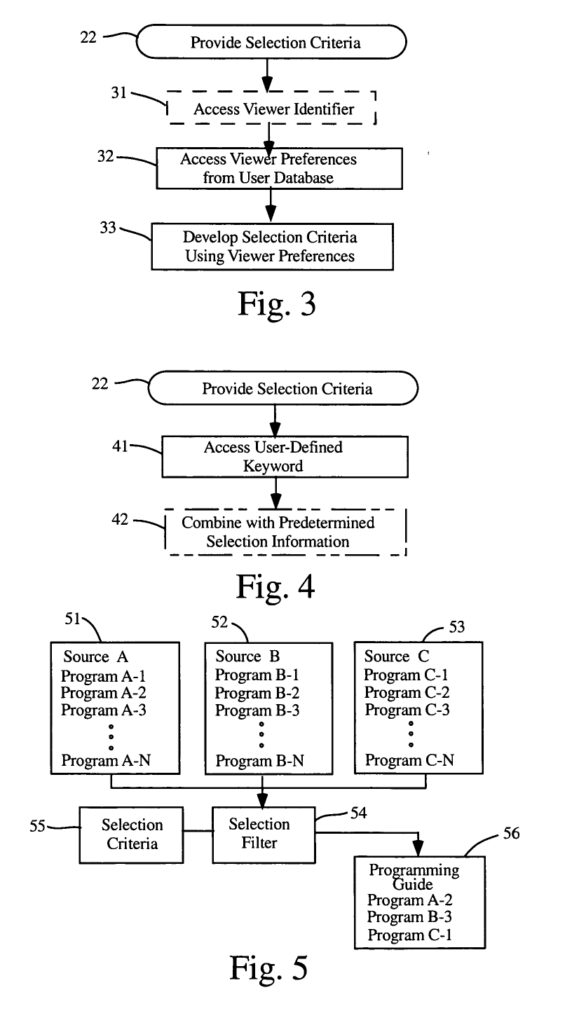

As one example, and referring momentarily to FIG. 3, this step 22 can optionally include accessing 31 an identifier for a given viewer (such as a password, user name, or the like). Such information can be gleaned, if already available, from a corresponding buffer or, if not previously received from the viewer, elicited by presenting the viewer with a specific request for such information. In the alternative to such a request, a given programming guide may presume only a single viewer. In either case, this step can then provide for accessing 32 one or more viewer preferences from a user database maintained at least for this purpose. Such viewer preferences can represent information as has been explicitly entered by the viewer (for example, during an initial registration process) or that has otherwise been deduced from the viewing behaviors of the viewer in the past. (It may also be possible to obtain such information from a preferences profile server to which this process has access and to which the viewer has contributed such information.) Such preferences can include information such as preferred genres, favorite actors, preferred viewing times, and so forth. This step can then use such viewer preference information to develop 33 the aforementioned selection criterion (or criteria). For example, upon determining that the viewer has a preference for action genre movies, a corresponding selection criterion can be formulated.

As another example, and referring now to FIG. 4, this step 22 can instead (or additionally) access one or more user-defined keywords. Such information can again be obtained in a manner consistent with the data that may be available to a given system. By one approach the viewer can be presented with a survey or other data-gathering process to elicit such keywords. Such a keyword (or keywords) can then be used as, or to facilitate the formulation of, the specific criterion specified above. In an optional approach, such keywords can be combined 42 with other predetermined selection information to facilitate the development of composite or multiply-faceted selection criterion or criteria.

Referring again to FIG. 2, the selection criterion (or criteria) are then applied 23 to the characterizing descriptors of the pool of programming options from varying sources to provide a resultant selection of items of audio/visual content. For example, if the selection criteria for a given viewer indicate a preference for documentaries and an interest in football, then the programming choices from all available sources would be subjected to a common review to identify all programs that relate to football and/or that are classified as a documentary. The process 20 then provides for the display 24 of programming guide information using this resultant selection of programming options.

FIG. 5 illustrates this process in schematic form. In this illustrative example, there are three different sources 51, 52, and 53 (such as, for example, a cable service, a satellite service, and an Internet-based service, respectively). Each source has a corresponding set of available programs, with each program being characterized by one or more characterizing descriptors. A selection filter 54 receives this information for each of the sources and uses a selection criterion (or criteria) 55 as provided above to process and filter the received information to identify matches. The resultant matches are then displayed, using a programming guide form factor 56, for the benefit of the viewer.

So configured, a viewer can see, review, and select from amongst candidate programs that are of likely potential interest to the viewer. It will also be appreciated that the viewer does not have to interact in different ways, or engage in duplicative reviews or behaviors, to facilitate their review of this material. Instead, for all intents and purposes, the viewer can essentially ignore the fact that these programming options are potentially offered by differing services/sources. This can save the viewer considerable time and aggravation.

Referring again to FIG. 2, in an optional but preferred approach, the process 20 will then support 25 programming guide navigation. For example, the viewer can use their remote control to review and browse the displayed program results and to select 26 a particular program for present viewing (or other corresponding action/response) 27 in accord with well understood practice in this regard.

It can therefore be seen that a viewer can review and navigate programming options from a variety of sources (and/or of a variety of types) in a transparent and highly intuitive fashion (making use of only a few basic and intuitive commands). These benefits can be realized without the need to access nested menus. These benefits also remain essentially intact even though one scales the information set upwardly to include a relatively large body of data and/or a relatively large number of content sources.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. A method comprising:
in an audio/video programming guide apparatus:
providing access to characterizing descriptors as individually correspond to a plurality of discrete selectable items of audio/video content, wherein at least some of the discrete selectable items of audio/video content differ from one another with respect to at least one of:
bearer media;
primary transmission service provider;
data format;
providing at least one selection criterion;
applying the at least one selection criterion with respect to the characterizing descriptors to provide a resultant selection of the plurality of discrete selectable items of audio/video content;
displaying programming guide information comprising information regarding at least a portion of the resultant selection.

2. The method of claim 1 further comprising:
responding to a remote control by scrolling through the programming guide information comprising information regarding at least a portion of the resultant selection.

3. The method of claim 1 further comprising:
detecting user selection of a particular one of the plurality of discrete selectable items of audio/visual content.

4. The method of claim 1 further comprising a user database and wherein providing at least one selection criterion further comprises using information from the user database to characterize the at least one selection criterion to be provided.

5. The method of claim 4 wherein using information from the user database to identify the at least one selection criterion to be provided comprises:
accessing information from the user database to discern preferences of a particular user;
accessing the characterizing descriptors as individually correspond to a plurality of discrete selectable items of audio/video content;
comparing the preferences of a particular user to the characterizing descriptors as individually correspond to a plurality of discrete selectable items of audio/video content.

6. The method of claim 4 further comprising:
responding to a remote control by selecting a particular one of the plurality of discrete selectable items of audio/visual content.

7. The method of claim 1 wherein providing at least one selection criterion comprises:
supplying at least one user-defined keyword; and
matching the at least one user-defined keyword with at least one of the characterizing descriptors as individually correspond to a plurality of discrete selectable items of audio/video content.

8. An interactive programming guide comprising:
characterizing descriptors as individually correspond to a plurality of discrete selectable items of audio/video content, wherein at least some of the discrete selectable items of audio/video content differ from one another with respect to at least one of:
bearer media;
primary transmission service provider;
data format;
at least one selection criterion;
control circuitry that:
applies the at least one selection criterion with respect to the characterizing descriptors to provide a resultant selection of the plurality of discrete selectable items of audio/video content;
displays programming guide information comprising information regarding at least a portion of the resultant selection.

9. The interactive programming guide of claim 8 wherein the control circuitry comprises filter means for comparing the at least one selection criterion with at least some of the characterizing descriptors to provide the resultant selection.

10. The interactive programming guide of claim 8 and wherein the at least one selection criterion is based, at least in part, upon a preference of a present viewer of the interactive programming guide.

11. The interactive programming guide of claim 8 wherein the at least one selection criterion comprises a user-defined keyword.

12. The interactive programming guide of claim 8 wherein the at least one selection criterion is retained in a database.

13. A method of providing a programming guide comprising:
in an audio/video programming guide apparatus:
providing access to characterizing descriptors as individually correspond to a plurality of discrete selectable audio/visual programs, wherein at least some of the discrete selectable audio/visual programs are supplied by different content service providers;
providing at least one selection criterion that corresponds to a given individual;
applying the at least one selection criterion with respect to the characterizing descriptors to provide a resultant selection of the plurality of discrete selectable audio/visual programs;
displaying programming guide information comprising information regarding at least a portion of the resultant selection.

14. The method of claim 13 wherein providing at least one selection criterion that corresponds to a given individual further comprises ascertaining an identity of a present viewer.

15. The method of claim 14 wherein providing at least one selection criterion that corresponds to a given individual further comprises further comprises using the identity to recall at least one previously stored selection criterion.
